(19) United States
(12) Patent Application Publication
(10) Pub. No.: US 2022/0186637 A1
(43) Pub. Date: Jun. 16, 2022

(54) VALVE TRAIN WITH HYDRAULIC DELAY ELEMENT FOR AN INTERNAL COMBUSTION ENGINE

(71) Applicant: ABB Switzerland Ltd., Baden (CH)

(72) Inventors: Christoph MATHEY, Fislisbach (CH); Raphael RYSER, Baden (CH); Andreas STREBEL, Freienwill (CH)

(21) Appl. No.: 17/599,412

(22) PCT Filed: Mar. 27, 2020
(86) PCT No.: PCT/EP2020/058812

§ 371 Date: Sep. 28, 2021

(30) Foreign Application Priority Data
Mar. 29, 2019 (EP) 19166327.7

(51) Int. Cl. F01L 1/14; F01L 1/18

(52) U.S. Cl. CPC F01L 1/146; F01L 9/10; F01L 1/185

(57) ABSTRACT

The disclosure relates to a valve train for an internal combustion engine and to an internal combustion engine. The valve train has an inlet valve actuation mechanism for the periodic actuation of an inlet valve of the internal combustion engine. The valve train also has a delay element, which is in contact with the inlet valve actuation mechanism and which has a hydraulic chamber for delaying a closing movement of the inlet valve by means of a hydraulic medium. The valve train has a hydraulic feed for feeding the hydraulic medium into the hydraulic chamber, the hydraulic feed having a control shaft, and the control shaft being mechanically driven by the internal combustion engine. The control shaft has an axially extended cavity for the hydraulic medium, and at least one opening for intermittently feeding the hydraulic medium from the cavity to the hydraulic chamber.

### CROSS REFERENCE TO RELATED APPLICATIONS

This patent application is a National Stage Entry of PCT/EP2020/058812 filed on Mar. 27, 2020, which claims the benefit and priority of European Patent Application No. 19166327.7 filed on Mar. 29, 2019, the disclosures of which are incorporated by reference herein in their entirety as part of the present application.

### BACKGROUND

The disclosure relates to a valve train for gas exchange in an internal combustion engine, and to an internal combustion engine.

Nowadays, internal combustion engines, especially large engines, in the medium-speed portion are increasingly being fitted with “Miller timing” and highly efficient high-pressure charging. The timing is characterized by the fact that the inlet closure takes place before bottom dead center. On the one hand, this embodiment has the effect that consumption falls and that, by virtue of the internal expansion, NOx emissions are considerably reduced; on the other hand, however, there is a negative effect on starting, acceleration and part-load operating behavior.

Owing to extreme Miller timings, the mass which enters the cylinder, at idle for instance, is so small that the required ignition temperature is not achieved in the compression phase in the case of a diesel engine, and it is thus impossible to start the engine. Moreover, filling in a large range of part-load operation is so low that smoke-free combustion cannot be ensured at acceptable exhaust gas temperatures.

In the case of gas engines with Miller timing, the low temperature at the end of the compression phase has a negative effect on combustibility and hence on the running behavior of the engine. In general, the acceleration or response behavior can be negatively affected by Miller timing. At idle and in low-load operation, there may additionally be operating states in which there is an unwanted negative pressure gradient between the space above the piston and that below the piston.

Nowadays, various technologies are used as countermeasures to the in some cases unsatisfactory operating behavior of internal combustion engines with Miller timing at low loads. Some of these technologies aim to modify the inlet closure in part-load operation, for example.

In view of the factors mentioned above, there is a need for further improvements.

### BRIEF DESCRIPTION

Embodiments of the present disclosure are at least partially achieved by a valve train as claimed in claim 1 and furthermore achieved by an internal combustion engine as claimed in claim 15. Further embodiments, modifications, and improvements will become apparent from the following description and from the appended claims.

One embodiment of the present disclosure provides a valve train for an internal combustion engine. The valve train has an inlet valve actuation mechanism for the periodic actuation of an inlet valve of the internal combustion engine. Furthermore, the valve train has a delay element, which is in contact with the inlet valve actuation mechanism and which has a hydraulic chamber, for delaying a closing movement of the inlet valve by means of a hydraulic medium. Furthermore, the valve train has a hydraulic feed for feeding the hydraulic medium into the hydraulic chamber. The hydraulic feed has a control shaft, wherein the control shaft is mechanically driven by the internal combustion engine. The control shaft may be driven synchronously with the periodic actuation of the inlet valve. Furthermore, the control shaft has an axially extended cavity for the hydraulic medium, and at least one opening for intermittently feeding the hydraulic medium from the cavity to the hydraulic chamber.

One embodiment of the present disclosure provides an internal combustion engine. The internal combustion engine has at least one valve train in accordance with one of the embodiments disclosed herein.

In particular, embodiments of the disclosure can allow selective control of the delay element with a low outlay in terms of design and control. It is thereby possible to achieve an improvement in the part-load behavior of internal combustion engines in a simple and low-cost manner. Embodiments of the disclosure can therefore be used particularly for internal combustion engines with Miller timing and/or high requirements on the operating range.

### BRIEF DESCRIPTION OF THE DRAWINGS

The disclosure is explained in greater detail below by means of embodiments without the intention that these should restrict the scope of protection defined by the claims.

The appended drawings illustrate embodiments and, together with the description, serve to explain the principles of the disclosure. The elements of the drawings are relative to one another and are not necessarily true to scale. Identical reference signs denote correspondingly similar parts.

The figures show the following:

FIG. 1A is a schematic side view of one embodiment of a control shaft according to embodiments of the present disclosure;

FIG. 1B is a schematic cross-sectional view of the control shaft from FIG. 1A along the line B-B;

FIG. 2 is one embodiment of a valve train according to embodiments of the present disclosure;

FIG. 3 is another embodiment of a valve train according to embodiments of the present disclosure;

FIG. 4 is another embodiment of a valve train according to embodiments of the present disclosure; and

FIG. 5 is another embodiment of a valve train according to embodiments of the present disclosure.

### DETAILED DESCRIPTION

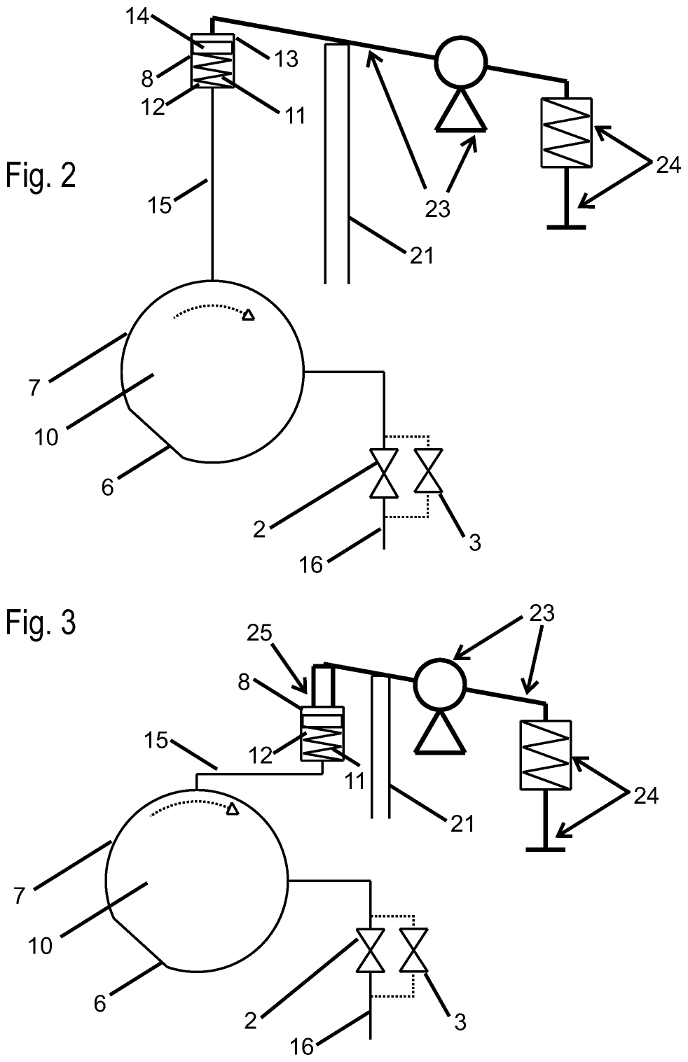

FIGS. 2-5 are schematic illustrations of various embodiments of a valve train 1. The valve train 1 is suitable for gas exchange in an internal combustion engine.

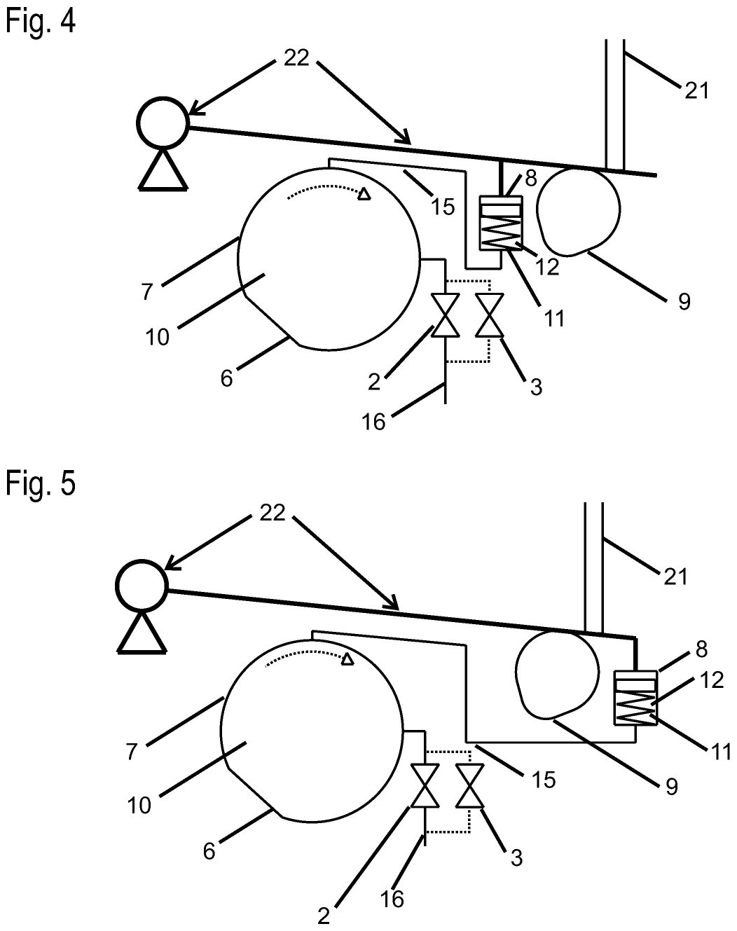

FIGS. 4 and 5 show part of the valve train on the camshaft side (e.g. a bottom part of the valve train in the case of a bottom-mounted camshaft), and FIGS. 2 and 3 show a part of the valve train on the valve stem side (e.g. an upper part of the valve train). These parts of the valve train can be connected to one another or to corresponding parts of a conventional valve train (e.g. without the delay element 8 shown in the figures and without a hydraulic feed) via a pushrod 21 partially shown in all the figures.

The valve train 1 has an inlet valve actuation mechanism 20 for the actuation of an inlet valve 24 of the internal combustion engine. The actuation of the inlet valve 24 of the internal combustion engine includes an opening movement and a closing movement of the inlet valve 24. The inlet valve actuation mechanism 20 has a kinematic chain of periodically moving elements for periodically pressing on a valve stem of the inlet valve. The periodic pressing actuates an opening movement, and the periodic removal of the pressure actuates a closing movement. The periodic movement of the elements of the inlet valve actuation mechanism 20 can be produced by a camshaft 9, for example, wherein the other elements transmit the periodic movement from the camshaft to the valve stem.

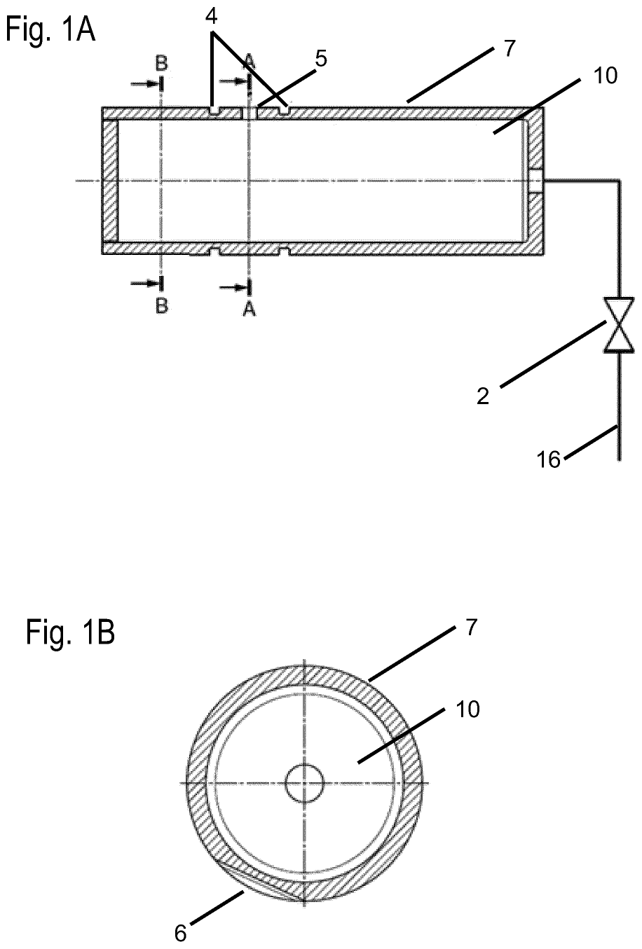

The inlet valve actuation mechanism 20 can have a finger follower 22, a rocker arm 23, a pushrod 21 and/or a valve bridge, for example, (as moving elements of the abovementioned kinematic chain). FIGS. 2 and 3 schematically show a rocker arm 23, FIGS. 4 and 5 show a finger follower 22, and FIGS. 1 to 4 show a pushrod 21, for example.

The valve train 1 furthermore has a delay element 8. The delay element 8 is in contact with the inlet valve actuation mechanism 20.

In one embodiment, the delay element 8 can have a hydraulic cylinder 13 and a hydraulic piston 14. Embodiments of the hydraulic cylinder 13 and of the hydraulic piston 14 are illustrated in FIGS. 2 to 5, for example. The hydraulic medium fed into the hydraulic chamber 12 can act upon the hydraulic piston 14. The hydraulic piston 14 can counteract the closing of the inlet valve actuation mechanism 20. Furthermore, the delay element 8 can have a spring device 11, which can counteract the closing movement of the inlet valve actuation mechanism 20.

The contact between the delay element 8 and the element of the inlet valve actuation mechanism 20 is, in particular, a coupling of the element with the hydraulic piston 14 in such a way that the opening movement of the element moves (pulls) the piston in a direction out of the hydraulic chamber 12, and the closing movement of the element moves (pushes) the piston in a direction into the hydraulic chamber 12.

In one embodiment, the delay element 8 can be connected mechanically to the inlet valve actuation mechanism 20. In another embodiment, the inlet valve actuation mechanism 20 can enter into contact with the delay element 8 during actuation, in particular during closure, of the inlet valve 24.

In this case, the delay element 8 can enter into contact with any element of the inlet valve actuation mechanism 20 which moves during actuation of the inlet valve 24. In one embodiment, the delay element 8 is in contact with the finger follower 22. FIGS. 4 and 5 show examples in which the delay element 8 is in contact with the finger follower 22. In another embodiment, the delay element 8 is in contact with the finger follower 22. FIGS. 2 and 3 show examples in which the delay element 8 is in contact with the rocker arm 22. FIG. 3 illustrates an embodiment wherein the rocker arm has an additional pushrod 25. In another embodiment, the delay element 8 is in contact with the valve bridge (not illustrated). In another embodiment, the delay element 8 is in contact with the pushrod 21 (not illustrated).

The delay element 8 has a hydraulic chamber 12 for delaying a closing movement of the inlet valve 24 by means of a hydraulic medium. The hydraulic medium can be engine oil or a separate servo oil circuit, for example.

The delay element 8 advantageously makes it possible to prevent premature closure of the inlet valve 24. When the hydraulic chamber 12 does not have any hydraulic medium, there is no delay or substantially no delay of the closing movement of the inlet valve 24. This may be desired particularly in full-load operation. In part-load operation, for example, a delay of the closing movement of the inlet valve 24 may be desired. Given the presence of the hydraulic medium in the hydraulic chamber 12, the closing movement of the inlet valve 24 can be delayed by the fact that the inlet valve actuation mechanism 20 presses or pushes the hydraulic medium out of the hydraulic chamber 12. Through the use of the valve train 1 according to one of the embodiments of the present disclosure, the negative consequences of the “Miller effect” or Miller timing can be eliminated, especially at idle and in part-load operation.

The hydraulic chamber 12 can be designed as a hydraulic cylinder formed to hold the hydraulic medium. A movable hydraulic piston 14 is arranged in the hydraulic chamber 12.

Furthermore, the valve train 1 has a hydraulic feed for feeding the hydraulic medium into the hydraulic chamber 12. The hydraulic feed has a control shaft 7. FIG. 1A is a schematic side view of one embodiment of a control shaft 7 according to the disclosure. FIG. 1B is a schematic cross-sectional view of the control shaft 7 from FIG. 1A along the line B-B. The control shaft 7 can have a cavity 10 for the hydraulic medium, in particular an axially extended cavity 10. In one embodiment, the cavity extends over almost the entire axial extent of the control shaft 7 (e.g. over at least 60% or at least 80% of the axial extent of the control shaft 7).

The hydraulic feed can have a feed line 16, which can be connected to the control shaft 7 in order to feed the hydraulic medium to the axially extended cavity 10. In particular, the feed line 16 can be a line leading to the engine, wherein engine oil can be used as the hydraulic medium.

The control shaft 7 can be driven mechanically by the internal combustion engine. The control shaft 7 may be driven synchronously with the periodic actuation of the inlet valve, i.e. synchronously with a camshaft 9 of the internal combustion engine, for example, in particular at the same speed as the camshaft 9. Driving the control shaft 7 synchronously with the camshaft 9 advantageously allows a defined orientation of the control shaft 7 for each orientation of the camshaft 9 (wherein the corresponding orientation of the control shaft 7 can be adjustable by means of a phase adjuster, for instance).

The control shaft 7 can have at least one opening 5. The opening 5 extends only over a portion of an outer circumference of the control shaft 7. In particular, the opening 5 does not extend over the entire outer circumference of the control shaft 7.

The hydraulic medium which is in the axially extended cavity 10 can emerge from the control shaft 7 via the opening 5. In particular, the opening 5 allows the intermittent feeding of the hydraulic medium from the axially extended cavity 10 of the control shaft to the hydraulic chamber 12 of the delay element 8.

In this case, the cavity 10 of the control shaft 7 can be brought into fluid communication with the hydraulic chamber 12 of the delay element 8 via a connecting line 15. The delay element 8 can have an opening in order to allow fluid communication between the hydraulic chamber 12 of the delay element 8 and the connecting line 15. In one embodiment, the connecting line 15 can be mounted and/or connected rigidly to the control shaft 7 and thus in a non-rotatable manner on the control shaft 7. In the case where the opening 5 of the control shaft 7 extends over only a portion of the outer circumference of the control shaft 7, the hydraulic medium is fed from the cavity 10 of the control shaft 7 to the hydraulic chamber 12 of the delay element 8 only when the control shaft 7 is in a particular orientation. The fluid communication between the cavity 10 and the hydraulic chamber 12 can be present when there is overlap between the opening 5 and the connecting line 15. By further rotation of the control shaft 7 or, in other words, if there is no overlap between the opening 5 of the control shaft 7 and the connecting line 15, the fluid communication from the cavity 10 to the hydraulic chamber 12 can be intermittently interrupted. According to one embodiment, the opening 5 of the control shaft 7, in particular the orientation of the control shaft 7 with respect to the camshaft 9, is arranged in such a way that intermittent feeding of the hydraulic medium from the cavity 10 to the hydraulic chamber 12 before or upon reaching a maximum valve lift of the inlet valve 24 is made possible.

According to one general aspect, the hydraulic feed thus has a connecting line 15 leading from the control shaft 7 to the hydraulic chamber 12. In this case, an inlet of the connecting line 15 is arranged in such a way that the opening 5 of the control shaft 7 moves over the inlet of the connecting line 15 periodically in order to feed in the hydraulic medium intermittently from the cavity 10. At a first rotation angle of the control shaft 7, the opening 5 of the control shaft 7 may overlap with the inlet of the connecting line 15, for instance, with the result that the hydraulic medium is fed in via the connecting line 15, and, at a second rotation angle of the control shaft 7, the opening 5 of the control shaft 7 may not overlap with the inlet of the connecting line 15, with the result that the feeding of the hydraulic medium is prevented.

The valve train 1 can furthermore have a switching valve 2, in particular an electromagnetic switching valve 2, arranged in the feed line 16. The switching valve 2 can be designed to open and close the feed line 16 (embodiments thereof are illustrated in the Figures). In particular, the switching valve 2 can be designed to open the feed line 16 in part-load operation. Intermittent feeding of the hydraulic medium from the cavity 10 to the hydraulic chamber 12 before a maximum valve lift of the inlet valve 24 is reached can thereby be made possible. In one embodiment, the switching valve 2 can be designed to close the feed line 16 when the internal combustion engine is running in full-load operation and/or is not running in part-load operation.

The valve train 1 can furthermore be designed to allow intermittent discharge of the hydraulic medium from the hydraulic chamber 12. In one embodiment, the hydraulic feed, the control shaft 7, can be designed to allow intermittent discharge of the hydraulic medium from the hydraulic chamber 12. In particular, the control shaft 7 can have a drain slot 6 for the intermittent discharge of the hydraulic medium from the hydraulic chamber 12 of the delay element 8 to the drain slot 6. In particular, a fluid connection from the hydraulic chamber 12 to the drain slot 6 can be intermittently opened and interrupted when the control shaft 7 is rotated.

Embodiments of the drain slot 6 are illustrated in FIGS. 1B, 2, 3, 4, and 5, for example. In one embodiment, the drain slot 6 is arranged on the outer circumference of the control shaft 7. The drain slot 6 can extend over a portion of the outer circumference of the control slot 7. In particular, the drain slot 6 does not extend over the entire outer circumference of the control shaft 7.

The drain slot 6 of the control shaft 7 can extend radially over a portion of the control shaft 7. In particular, the drain slot 6 of the control shaft 7 does not correspond to an opening and/or is substantially not in fluid communication with the axially extended cavity 10 of the control shaft 7. The drain slot 6 of the control shaft 7 can extend axially over a portion of the control shaft 7. In particular, the drain slot 6 extends axially only over a portion of the control shaft 7.

In one embodiment, the drain slot 6 of the control shaft 7 is arranged axially offset from the opening 5 of the control shaft 7. FIG. 1A, for example, illustrates an embodiment of the control shaft 7 in which the opening 5 of the control shaft 7 is arranged axially in the region of the line A-A, while the drain slot 6 of the control shaft 7 is arranged axially in the region of the line B-B.

The axially extended cavity 10 of the control shaft 7 and the drain slot 6 of the control shaft 7 are substantially not in fluid communication with one another. According to one embodiment, the control shaft 7 can have a seal in the region of the opening 5 in order to prevent the hydraulic medium from escaping in the region of the opening 5 of the control shaft 7. In particular, the control shaft 7 can have a sealing element, e.g. slotted piston rings 4 (one illustrative embodiment thereof is illustrated in FIG. 1A) or O-rings in order to prevent the hydraulic medium from escaping in the region of the opening 5 of the control shaft 7. It is thereby possible, in particular, to substantially avoid fluid communication between the opening 5 and the drain slot 6.

The drain slot 6 of the control shaft 7 can be brought into fluid communication with the hydraulic chamber 12 of the delay element 8. In one embodiment, the drain slot 6 of the control shaft 7 can be brought into fluid communication with the hydraulic chamber 12 of the delay element 8 via the connecting line 15. The connecting line 15 can fork, for example, and can thus be connected to the cavity 10 of the control shaft 7, to the drain slot 6 of the control shaft 7 and to the hydraulic chamber 12 of the delay element 8. In another embodiment, the delay element 8 has a second opening in order to allow fluid communication between the hydraulic chamber 12 of the delay element 8 and the drain slot 6 of the control shaft 7. The valve train 1 can have a second connecting line, which connects the hydraulic chamber 12 of the delay element 8 and the drain slot 6 of the control shaft 7.

In one embodiment, the connecting line 15 and/or the second connecting line can be mounted and/or connected rigidly to the control shaft and thus in a non-rotatable manner on the control shaft. In the case where the drain slot 6 of the control shaft 7 extends over only a portion of the outer circumference of the control shaft 7, the hydraulic medium is drained from the hydraulic chamber 12 of the delay element 8 to the drain slot 6 of the control shaft 7 only when the control shaft 7 is in a particular orientation. The fluid communication between the cavity 10 and the hydraulic chamber 12 can be present when there is overlap between the drain slot 6 and the connecting line 15 or the second connecting line. By further rotation of the control shaft 7 or, in other words, if there is no overlap between the drain slot 6 and the connecting line 15 or the second connecting line, the fluid communication from the hydraulic chamber 12 to the drain slot 6 can be intermittently interrupted. According to one embodiment, the drain slot 6 of the control shaft 7, in particular the orientation of the control shaft 7 with respect to the camshaft 9, is arranged in such a way that intermittent drainage of the hydraulic medium from the hydraulic chamber 12 to the drain slot 6 after maximum opening of the inlet valve 24 has been reached is made possible.

The valve train 1 according to embodiments of the present disclosure makes it possible to delay the closing movement of the inlet valve based on a mechanical solution. In particular, the valve train 1 according to embodiments of the present disclosure does not require any electric and/or electromagnetic components to delay the closing movement of the inlet valve. Electric and/or electromagnetic components can lead to considerable additional expenditure, especially in the context of control and possible calibration of the closing movement of the inlet valve.

FIGS. 2 and 3 each illustrate valve trains 1 according to one embodiment. Here, the delay element 8 is in contact with the rocker arm 23 of the inlet valve actuation mechanism 20. The pushrod 21 is only partially illustrated in FIGS. 2 and 3. The arrow in broken lines indicates a direction of rotation of the control shaft 7, which should not be regarded as restrictive. Alternatively, the control shaft 7 can rotate counterclockwise. In both of the embodiments illustrated in FIGS. 2 and 3, the delay of the closing movement of the inlet valve 24 can be achieved through the ability of the delay element 8 filled with the hydraulic medium to delay the movement of the rocker arm 23 and, as a result thereof, also the closing movement of the inlet valve 24.

FIGS. 4 and 5 each illustrate valve trains 1 according to one embodiment. Here, the delay element 8 is in contact with the finger follower 22 of the inlet valve actuation mechanism 20. The pushrod 21 is only partially illustrated. In both of the embodiments illustrated in FIGS. 4 and 5, the delay of the closing movement of the inlet valve 24 can be achieved through the ability of the delay element 8 filled with the hydraulic medium to delay the movement of the finger follower 22 and, as a result thereof, also the closing movement of the inlet valve 24.

According to one embodiment, the valve train 1 can have a drivetrain for the switching valve 2. The drivetrain can have a phase adjuster for varying a closing time of the feed line 16, wherein the variation may be speed- and/or load-dependent. In another embodiment, the phase adjuster can modify the orientation of the control shaft 7 relative to the camshaft 9. The phase adjuster thus makes it possible to modify a time of the intermittent feeding of the hydraulic medium to the hydraulic chamber 12.

According to one embodiment, the valve train 1 can have a bypass valve 3 for bypassing the switching valve 2, wherein the feeding of the hydraulic medium into the axially extended cavity 10 of the control shaft 7 is made possible by actuation, may be mechanical or electric actuation, of the bypass valve 3. The bypass valve 3 makes possible failsafe operation.

According to one embodiment, an internal combustion engine is provided. The internal combustion engine can have a multiplicity of valve trains 1 in accordance with one of the embodiments disclosed herein. In particular, a fluid connection from the control shaft 7 to the hydraulic chambers 12 of all the delay elements 8 can be intermittently opened and interrupted when the control shaft is rotated.

In this case, the control shaft 7 can have a multiplicity of openings 5 and/or a multiplicity of drain slots 6. The valve trains 1 disclosed herein and the internal combustion engines advantageously enable feeding of the hydraulic medium from the hydraulic feed, preferably the control shaft 7, to the hydraulic chambers 12 of all the delay elements 8 and the discharge of the hydraulic medium from the hydraulic chambers 12 of all the delay elements 8 to the hydraulic feed, preferably to the control shaft 7. A delay to the closing movement of the inlet valves of all the valve trains 1 by the control shaft 7 is thus made possible. There is advantageously no need for individual electric or electromagnetic controls or separate devices for each valve train 1, e.g. a hydraulic medium servo circuit for each valve train of the internal combustion engine, in order to delay the closing movement of the inlet valves 24. Instead, it is possible according to the disclosure for the control shaft 7 to supply all the hydraulic chambers 12 of the internal combustion engine with the hydraulic medium without requiring electric and/or electromagnetic components to distribute the hydraulic medium. A simple and low-cost design is thus advantageously presented, wherein, at the same time, reliable and accurate control of the delay elements 8 is ensured and the power requirement is reduced.

In particular, the switching valve 2 arranged in the feed line 16 enables the hydraulic medium to be fed from the cavity 10 of the control shaft 7 into the hydraulic chambers 12 of all the delay elements 8.

Although specific embodiments have been illustrated and described herein, it is possible, within the scope of the present disclosure, to modify the embodiments shown in a suitable way without exceeding the scope of protection of the present disclosure.

1. A valve train for an internal combustion engine, the valve train comprising:
an inlet valve actuation mechanism for the periodic actuation of an inlet valve of the internal combustion engine;
a delay element, which is in contact with the inlet valve actuation mechanism and which has a hydraulic chamber, for delaying a closing movement of the inlet valve by means of a hydraulic medium;
a hydraulic feed for feeding the hydraulic medium into the hydraulic chamber,
wherein the hydraulic feed has a control shaft, wherein the control shaft is mechanically driven by the internal combustion engine; and
wherein the control shaft has an axially extended cavity for the hydraulic medium, and at least one opening for intermittently feeding the hydraulic medium from the cavity to the hydraulic chamber.

2. The valve train according to claim 1, wherein the inlet valve actuation mechanism comprises:
a rocker arm, wherein the delay element is in contact with the rocker arm; and/or
a finger follower, wherein the delay element is in contact with the finger follower; and/or
a pushrod, wherein the delay element is in contact with the pushrod; and/or
a valve bridge, wherein the delay element is in contact with the valve bridge.

3. The valve train according to claim 1, wherein the hydraulic feed has a feed line, connected to the control shaft, for feeding the hydraulic medium into the axially extended cavity.

4. The valve train according to claim 3, furthermore having a switching valve arranged in the feed line.

5. The valve train according to claim 1, wherein the cavity of the control shaft can be brought into fluid communication with the hydraulic chamber of the delay element via a connecting line.

6. The valve train according to claim 1, wherein the opening of the control shaft is arranged in such a way that intermittent feeding of the hydraulic medium from the cavity to the hydraulic chamber before or upon reaching a maximum valve lift of the inlet valve is made possible.

7. The valve train according to claim 1, wherein the hydraulic chamber is designed as a hydraulic cylinder, and the delay element furthermore has a hydraulic piston, wherein the hydraulic piston is arranged movably in the hydraulic chamber to enable it to be acted upon in such a way by the hydraulic medium fed into the hydraulic chamber that the hydraulic piston acted upon by the hydraulic medium counteracts the closing movement of the inlet valve actuation mechanism.

8. The valve train according to claim 1, wherein the control shaft has a drain slot for the intermittent discharge of the hydraulic medium from the hydraulic chamber to the drain slot and through the drain slot, slot.

9. The valve train according to claim 1, wherein the drain slot of the control shaft is arranged in such a way that intermittent discharge of the hydraulic medium from the cavity to the drain slot after a maximum opening of the inlet valve has been reached is made possible.

10. The valve train according to claim 8, wherein the drain slot of the control shaft extends radially over a portion of the control shaft, and/or the axially extended cavity of the control shaft and the drain slot of the control shaft are not in direct fluid communication.

11. The valve train according to claim 1, wherein the delay element has a spring device which counteracts the closing movement of the inlet valve actuation mechanism.

12. The valve train according to claim 1, furthermore having a bypass valve for bypassing the switching valve, wherein the feeding of the hydraulic medium into the axially extended cavity of the control shaft is made possible by actuation.

13. The valve train as according to claim 8, wherein the drain slot of the control shaft is arranged axially offset from the opening of the control shaft.

14. The valve train according to claim 1, wherein the valve train comprises:
a multiplicity of inlet valve actuation mechanisms for the periodic actuation of a corresponding number of inlet valves of the internal combustion engine;
a multiplicity of delay elements, which are in contact with respective inlet valve actuation mechanisms and which have respective hydraulic chambers for delaying a closing movement of the respective inlet valve by means of a hydraulic medium,
wherein the hydraulic feed has a control shaft, wherein the control shaft is mechanically driven by the internal combustion engine; and
wherein the control shaft has an axially extended cavity for the hydraulic medium, and respective openings for intermittently feeding the hydraulic medium from the cavity to the respective hydraulic chambers, such that a fluid connection from the control shaft to the hydraulic chambers of the respective delay elements is intermittently opened and interrupted when the control shaft is rotated.

15. An internal combustion engine having at least one valve train according to claim 1.

16. The valve train according to claim 8, wherein the drain slot is arranged on an outer circumference of the control shaft.

17. The valve train according to claim 1, wherein the control shaft is mechanically driven synchronously with the periodic actuation of the inlet valve.
